(19) United States
(12) Patent Application Publication
(10) Pub. No.: US 2001/0019775 A1
(43) Pub. Date: Sep. 6, 2001

(54) Moisture-degradable alkali oxide siliceous material, and electromagnetic radiation-interactive article comprising same

(76) Inventor: Richard H. Warfel, Apollo Beach, FL (US)

Correspondence Address: INTELLECTUAL PROPERTY / TECHNOLOGY LAW, PO BOX 14329, RESEARCH TRIANGLE PARK, NC, 27709, US

(21) Appl. No.: 09/770,575

(22) Filed: Jan. 26, 2001

Related U.S. Application Data
(62) Division of application No. 09/010,460, filed on Jan. 21, 1998, now abandoned.

(51) Int. Cl. B32B 9/00

(52) U.S. Cl. 428/469; 428/472; 428/701; 428/702

(57) ABSTRACT

An alki oxide siliceous material that is degradable in the presence of moisture. The material is formed by fusing R₂O and SiO₂ to form a R₂O:SiO₂ composition wherein each R is independently selected from Group I alkali metals. The alkali oxide siliceous material may be employed to form a substrate which can be metallized with an oxidizable metal such as aluminum to form a moisture-degradable chaff article.

### GOVERNMENT RIGHTS IN INVENTION

This invention was made with Government support under Contract No. N00019-95-C0033 awarded by the United States Naval Research Laboratory. The Government has certain rights in this invention.

### BACKGROUND OF THE INVENTION

1. Field of the Invention

This invention relates to a moisture-degradable alkali oxide siliceous material having utility in applications where a moisture-degradable material is required, such as for use in a substrate element of a chaff article with electromagnetic radiation response characteristics for electronic warfare countermeasure applications.

2. Description of the Related Art

“Chaff” and “expendables” are commonly used terms describing a plurality of electromagnetically tuned reflector dipoles used as electronic warfare counterneasures. Chaff has been used since World War II and is typically in the form of non-degradable metal flakes, strips, or metal-coated elements that attenuate electromagnetic waves and that prevent enemy radar from acquiring the exact location of an asset. Chaff dipoles are deployed to camouflage aircraft, ships, missiles, and ground equipment from radar-guided weaponry by forming a radar-saturating chaff cloud surrounding the target. The chaff confuses the enemy's electronic detection abilities and masks the actual location of the target.

Recent chaff products are typically constructed of fine diameter glass fibers coated with aluminum. The customary substrate used for aluminized glass chaff is E-glass, a low alkali borosilicate glass. E-glass is very durable, having a higher softening temperature than common silica glass and also having a better resistance to attack by acids. Chaff made from E-glass does not, therefore, degrade in the environment at an appreciable rate.

It is considered a significant problem to dispense a non-degradable chaff product into the environment. In warfare operations, non-degradable chaff material persists within the environment and can compromise friendly force weaponry and monitoring equipment.

In domestic training use, the persistence of non-degradable chaff in the environment is a regulatory issue, and the objections to non-degradable chaff implicate the need for degradable chaff which can be readily dissipated in the environment.

Since a degradable chaff product has not been available, military training with chaff has largely been suspended. The inability to train can affect combat-readiness and survivability of aircraft and military personnel.

U.S. Pat. No. 5,571,621 discloses an infrared radiation-interactive article comprising an oxidizable metal film. The metal film may be supported on a substrate of suitable material. The patent mentions that the substrate may be formed of a biodegradable material such as a water-soluble material, which is readily broken down in the environment in which the article is employed.

Related patents identified in column 1 of U.S. Pat. No. 5,571,621 disclose other radiation-interactive articles, which may utilize substrates of degradable materials such as boria (B₂O₃).

Unfortunately, the biodegradable substrate materials proposed by the prior art do not have high temperature tolerance for molten metal bath coating operations, such as are desirably employed for high rate production of chaff fiber with coatings of metals such as aluminum. In consequence, the prior art degradable materials typically utilize lower temperature metallization processes such as chemical processes or evaporative coating processes, which have inherent limits as to process throughput.

Accordingly, it would be a significant advance in the art, and is an object of the present invention, to provide a material of a degradable character which is amenable to high-rate coating with molten metal bath exposure of the material.

It is another object of the invention to provide an electromagnetic radiation countermeasure article which degrades rapidly to an environmentally benign state, and is cost-effective to manufacture.

Other objects and advantages of the present invention will be more fully apparent from the ensuing disclosure and appended claims.

### SUMMARY OF THE INVENTION

The foregoing problems of the prior art are resolved by the provision of a degradable material which is usefully employed as a substrate material of construction for electromagnetic radiation-interactive articles including a metal film thereon.

The invention relates in one aspect to an alkali oxide siliceous material that is degradable in the presence of moisture.

In another aspect, the present invention relates to a metal-coated substrate article, wherein the substrate is formed of a degradable alkali oxide siliceous material, and the metal is an oxidizable metal. In the presence of moisture, the alkali oxide is leached from the composition and forms alkali metal hydroxides which are reactive toward the metal coating, to effect oxidation thereof.

In another aspect, the present invention relates to a degradable vitreous oxide of the general composition R₂O:SiO₂, wherein R is a Group I alkali metal (sodium, lithium, potassium, rubidium, cesium or francium), wherein each R may be the same as or different from the other and the composition has a preferable molar ratio of R₂O to SiO₂ in the range of from about 1:1 to about 1:6, with a most preferable ratio range being from about 1:2 to about 1:4. Varying the R₂O to SiO₂ molar ratio affects certain properties of alkali oxide siliceous material including viscosity and moistures

In another aspect, the invention relates to a method of making a moisture-degradable vitreous oxide of the type described in the preceding paragraph. Such method comprises blending together the oxides R₂O and SiO₂ or the precursors of such oxides, and heating the resulting blend at elevated temperature until the blended oxides fuse with one another to form a vitreous oxide composition.

While the invention relates to metal coated articles of alkali oxide siliceous materials of the general form R₂O:SiO₂, it will be clear to those skilled in the art that, without departing from the spirit and scope of the invention, other ingredients or their precursors, including, but not limited to, the following list, may be added to the compositions for the purpose of modifying properties, such as viscosity and moisture sensitivity: Al₂O₃, B₂O₃, BaO, CaO, F₂, Fe₂O₃, MgO, MnO, MoO₃, P₂O₅, SrO, WO₃ and ZnO.

A fiber conformation of the vitreous oxide composition may be processed by passage thereof through a fiber-forming bushing to form a filament. The bushing may be fabricated of an alloy of platinum and platinum group metals, or of other suitable material. By passage through the bushing, the vitreous oxide composition is drawn into a filament. The filament may then be contacted with a molten metal to apply a metal coating to the fiber. The molten metal may be aluminum or other suitable metal composition.

In yet another aspect, the present invention relates to a chaff article, comprising a vitreous oxide substrate having the compositions variously described above, coated with a metal film. The metal film is of an electromagnetic radiation-interactive size and shape. The metal film and alkali oxide siliceous material are arranged so that in exposure to ambient moisture the metal film is dissolvable to an electromagnetic radiation-non-interactive form.

In still yet another aspect, the present invention -relates to an environmentally degradable electromagnetic radiation-interactive article having a metal coating that also exhibits evanescent characteristics by having the alkali oxide components of the material form metal hydroxides (upon exposure to moisture) that render the metal coating non-interactive with radar thereby producing the evanescent response.

The metal film coating may be doped with a dopant material to facilitate oxidation and degradation of the metal film. The dopant material may comprise a salt such as those disclosed in U.S. patent application Ser. No. 08/776,216, the disclosure of which are hereby incorporated by reference. Such suitable groups of dopant salts include, but are not limited to, metal halide, metal sulfate, metal nitrate, metal citrate and metal acetate. Specific species of salts may include lithium chloride, sodium chloride, potassium chloride, zinc chloride, iron(III)chloride and copper sulfate.

Another aspect of the invention relates to a method of making an electromagnetic radiation-interactive article, including forming a substrate having the composition R₂O:SiO₂, wherein R is a Group I alkali metal and the substrate composition has a preferable molar ratio of R₂O to SiO₂ in the range of from about 1:1 to about 1:6, with a most preferable ratio range of from about 1:2 to about 1:4, and applying a metal coating to the substrate.

Other aspects, features and embodiments of the invention will be more fully apparent from the ensuing disclosure and appended claims.

### BRIEF DESCRIPTION OF THE DRAWINGS

FIG. 1 is a perspective view of a flake conformation of an electromagnetic radiation-interactive article according to one embodiment of the present invention.

FIG. 2 is a front elevation view, showing a portion of the metal coating broken away, of a spherically shaped electromagnetic radiation-interactive article according to a second embodiment of the present invention.

FIG. 3 is an isometric view of a fiber conformation of an electromagnetic radiation-interactive article according to another embodiment of the present invention.

FIG. 4 illustrates a preferred method of manufacturing a fiber conformation of an electromagnetic radiation-interactive article according to another embodiment of the present invention.

### DETAILED DESCRIPTION OF THE INVENTION, AND PREFERRED EMBODIMENTS THEREOF

While the invention is illustratively described hereinafter with reference to an electromagnetic radiation-interactive article, it will be recognized that the invention is not thus limited, but broadly encompasses the alkali oxide siliceous material of the invention per se, as well as the utilization of such material in other structures, devices, articles and applications in which the degradable character of the material may be used to advantage.

Examples of such alternative uses include temporary structural applications, in which the moisture-degradable character of the alkali oxide siliceous material is beneficial. Another application is in dispensing of crop protection compositions which are encapsulated in such siliceous material as a delivery article, and which in response to moisture exposure conditions, such as relative humidity, precipitation, irrigation, etc., degrade to release the crop protection composition (herbicide, pesticide, etc.).

Preferably, however, the siliceous material of the invention is employed in association with a thin metal coating, in applications such as environmentally degradable chaff, in which moisture exposure results in the alkali metal oxide of the composition forming alkali metal hydroxides which are reactive toward the metal coating to degrade same to corresponding oxide or hydroxide forms. Additionally, the alkali oxide siliceous material itself is degradable upon exposure to moisture. When the alkali oxide is leached from the substrate, the physical structure breaks down. The metal coated article breaks down physically as the substrate breaks down. This type of environmentally degradable chaff differs from material coated articles that have been described as simply “evanescent” materials. Electromagnetic radiation-interactive articles that exhibit evanescent characteristics, meaning they have a relatively transient response with regard to their ability to interact with electromagnetic energy, are not necessarily environmentally degradable.

The metal-coated substrate article of the invention therefore may be usefully employed as a chaff, or in other application in which the accelerated moisture-mediated oxidation of a metal film or coating is desired. In the application of chaff, military as well as nonmilitary uses are contemplated (illustrative non-military uses may include a search and rescue tool deployed by lost persons, a survey or cartographic tool for determining locations, meteorological cloud seeding, etc.)., Another application example is a moisture-sensitive switch or sensor, in which the metal film is conductive in the absence of moisture, but which upon moisture exposure is rapidly oxidized to a non-conductive form. The switch or sensor article thereby functions as a circuit-breaker structure which may be utilized to actuate an alarm or apparatus carrying out a function relating to the presence of moisture in the monitored environment.

The degradable material of the invention therefore is seen to have broad applicability to a variety of end uses.

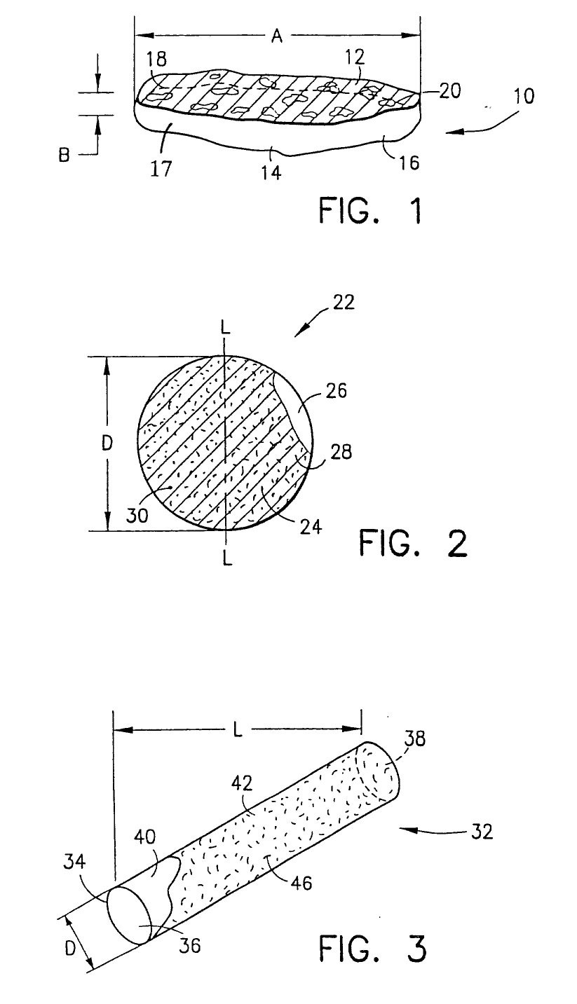

Referring now to the drawings, FIG. 1 is a perspective view of a flake conformation of an electromagnetic radiation-interactive article 10 according to one embodiment of the present invention. The article comprises a main body portion having main top face 12 and main bottom face 14 defining a thickness B therebetween associated with the edge surface 16. The face 12 of the flake article has a maximum edge-to-edge dimension A. The dimension A may, for example, be 10 microns, and the dimension B may, for example, be 0.5 microns.

The flake article main body portion constitutes a substrate element 17 having a metal film 18 thereon. The substrate element is formed of an alkali oxide siliceous material. The alkali oxide siliceous material may be co-formed with the metal film, or otherwise have the metal film deposited thereon. The metal film may be doped with deposits 20 of a suitable salt which acts to accelerate the oxidation of the metal film under atmospheric moisture or other ambient humidity or moisture exposure conditions. The article shown in FIG. 1 in exposure to environmental moisture responds with the alkali oxide leaching from the substrate body and forming alkali metal hydroxides which are reactive toward the metal film 18.

Ambient moisture exposure therefore serves to effect a rapid oxidation of -the metal coating under the impetus of the alkali metal hydroxides, thereby converting the conductive electromagnetic radiation-interactive metal film to an oxidized, non-interactive condition. Accordingly, in chaff applications, the evanescent character of the article of the invention permits dissipation of the radar “signature” of the article within an accelerated time-frame, relative to the radar signature life of a corresponding article lacking the substrate of the present invention.

The specific size, shape, and conformation of the chaff article of the invention may readily be determined without undue experimentation for a given electromagnetic radiation wavelength by the simple expedient of varying the size, shape, and/or conformation of the article and measuring the electromagnetic radiation interaction characteristic of interest (reflectance, absorption, scattering).

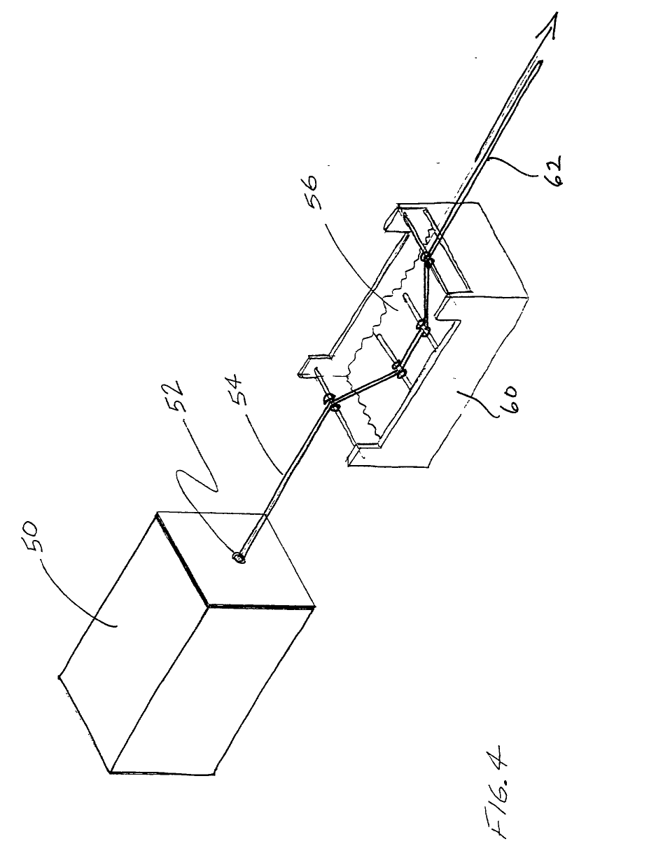

The substrate thickness dimension for a particulate chaff article, as described hereinafter in connection with FIG. 2, is the diameter of the particle less the thickness of the metal coating, which, in the case of the spherical conformation would be the particle diameter D less twice the coating thickness. In the case of a non-particulate article in flake form, the surface of the substrate article (transverse to its thickness) has an edge-to-edge dimension which desirably does not exceed 200 microns. In the case of a fiber conformation, as described hereinafter in connection with FIG. 3, the diameter of the article generally does not exceed 100 microns, more preferably does not exceed about 30 microns, and most preferably does not exceed about 25 microns, while the fiber length may range from several microns to several inches to even several feet. The fiber length may vary over a wide range to render the article electromagnetically interactive at the frequencies of interest.

The substrate of the chaff article of the invention comprises a non-conductive body in the desired conformation, with such substrate body being formed of a moisture-degradable material having the composition R₂O:SiO₂, wherein R is a Group I alkali metal (sodium, lithium, potassium, rubidium, cesium or francium), or a combination of Group I alkali metals and the substrate composition has a molar ratio of R₂O to SiO₂ that is the range of from about 1:1 to about 1:6, with a preferred molar ratio of from about 1:2 to about 1:4. In the composition R₂O:SiO₂, each of the R groups of the composition may be the same as or different from the other. The moisture-degradable material may comprise a mixture of different alkali oxide siliceous compositions, in which each of the components has differing R groups, e.g., the material may be made up of a combination of different R₂0:SiO₂ components, such as for example Na₂O:SiO₂, LiCsO:SiO₂, and Rb₂O:SiO₂. Any suitable compatible components of such type may be employed in the degradable vitreous alkali oxide siliceous material of the invention, in such combination materials. Exposure of the vitreous R₂O:SiO₂ material of the invention to ambient moisture causes alkali metal oxide to leach from the siliceous substrate and form base alkali metal hydroxides. Utilizing aluminum as an illustrative metal for the metal film coated on the moisture-degradable substrate, moisture exposure causes the alkali metal hydroxide to form and to react with water and the aluminum to produce an aluminate. For example, when sodium hydroxide is the alkali metal hydroxide, it will react with aluminum and water to form sodium aluminate by the following reaction:

2Al(s)+2 NaOH(aq)+6 H₂O(l)→2NaAl(OH)₄(aq)+3H₂(g).

As another example, when R=potassium in the siliceous substrate material R₂O:SiO₂, potassium hydroxide will be formed and react with aluminum and water to form potassium aluminate:

2Al(s)+2KOH(aq)+6H₂O(t)→2KAl(OH)₄(aq)+3H₂(g).

Accordingly, the foregoing degradative reaction causes the metal (alumina in the specific examples given, although any other suitable oxidizable metals may be employed for such purpose) to be oxidized to a form which is non-conductive and does not produce a radiation-interactive signature in response to incident radiation such as radar (or other radiation having a dipole interaction with the metal coating). The chaff article therefore has an evanescent radar-interactive signature which can be utilized for decoy and concealment purposes in a warfare theater or other operational site.

Referring again to the drawings, FIG. 2 is a front elevation view, partially broken away, of a particulate conformation of an electromagnetic radiation-interactive article 22 according to another embodiment of the invention. The article 22 is spherically shaped, being symmetrical about axis L-L, with a diameter D, which as indicated may be on the order of 1.5 microns or less, e.g., 0.2 to 1.0 micron. The article 22 in the embodiment shown comprises a non-conducting alkali oxide siliceous material, R₂O:SiO₂, formed into a spherical support body 26 whose outer surface has a coating 28 of metal thereon. The metal film may be of any suitable thickness, e.g., either sub-micron or greater than 1 micron in thickness, as appropriate to the desired end use of the article. The metal film may be doped with deposits 24, 30 of a salt or other medium, to enhance the ambient exposure oxidation of the metal film. For example, the article may include doping or discontinuous surface application of a salt as well as a hygroscopic material which will rapidly take up atmospheric moisture in exposure to ambient humidity conditions.

FIG. 3 is an isometric view, partially broken away, of a fiber conformation of an electromagnetic radiation-reflective article 32 according to a further embodiment of the invention. In this embodiment, the article 32 comprises a fiber substrate 34 formed of alkali oxide siliceous material of the composition R₂O:SiO₂, wherein R is a Group I alkali metal or a combination of Group I alkali metals, as previously described. The substrate 34 has respective circular-shaped end faces 36 and 38 of diameter D, with a main cylindrical outer surface 40 defining a length L of the fiber and having coated thereon the metal film 42.

The metal film 42 may be doped with dopant material 46 such as a salt, hygroscopic material, and/or any other material applied continuously or discontinuously to the film which acts to promote the degradative action in exposure of the article to moisture.

As an illustrative example of the manufacture of radiation-interactive articles of the present invention, the substrate may be formed by blending the oxides R₂O and SiO₂, and/or precursors of such oxides, and heating the blended oxides in a furnace until the oxide materials are fused to form a moisture-degradable vitreous oxide having the general composition R₂O:SiO₂ with R substituents as previously described.

For this purpose, the alkali metal oxide and the silica may be introduced into a crucible or other containment vessel which is placed in an elevated temperature oven or furnace to effect the fusion of the materials and yield a fused mass constituting the degradable vitreous oxide material R₂O:SiO₂ of the present invention. The degradable vitreous oxide composition then may be processed to form the substrate body for subsequent metallization or other use.

The substrate formed of R₂O:SiO₂ may be coated with a metal by any suitable process, such as molten metal submersion or contact, by chemical or evaporative coating processes, or by any other technique or method known in the art.

In forming a chaff article by metallization of the vitreous oxide substrate of the present invention, a metallizing process may be carried out as shown in FIG. 4.

As illustrated, the vitreous oxide composition, at a suitable temperature so as to be formable, is contained in the supply vessel 50 as a source of the formable vitreous oxide material. The vitreous oxide material through application of suitable pressure thereon is forced to flow through a fiber forming bushing orifice 52 and is drawn into fine diameter fiber 54.

The bushing may be fabricated of platinum, an alloy of platinum, or an alloy of platinum and platinum group metals.

The vitreous R₂O:SiO₂ fiber 54 is then contacted with a bath 56 of molten aluminum in vessel 60, to form an aluminun coating on the fiber and produce a resultingly metallized fiber 62. The metallized R₂O:SiO₂ fiber may for example have a diameter of 25 microns and may be coated with a 0.1-3 micron thickness of metal coating, depending upon the type of metal coating selected. The metallized fiber may then be cut into dipole lengths, or packaged in filament form for subsequent cutting and use, or otherwise utilized or processed in a manner consistent with its end use.

The following are examples offered to further illustrate the present invention. These examples are intended to be purely exemplary and should not be viewed as a limitation on the claimed invention.

A convenient method of evaluating degradable substrate materials is to expose them to boiling water. Conventional chaff E-glass substrates survive many hours of exposure to boiling water without any significant morphological changes. Substrates are considered degradable if they are soluble or exhibit gross deterioration after 1 hour of exposure to boiling water.

Observations were made on samples of materials stored in aluminum pans in a laboratory environment. Changes in physical appearance after a brief boiling water exposure indicated a degree of degradability. Another indication of degradability is the degree to which the material is hygroscopic. If the candidate material accumulated moisture or became sticky it was considered to be hygroscopic.

### EXAMPLE 1

15 grams of SiO₂ and 19.6 grams of K₂CO₃—H₂O were combined together by mixing using an alumina mortar and pestle. The mixture was placed in an alumina crucible and was heated in a laboratory furnace held at 1200° C. to yield clear vitreous oxide with the composition of 68 mole percent SiO₂ and 32 mole percent K₂O. Fibers were extracted from the molten mass by inserting a glass rod into the mass and drawing out the fiber.

Additional samples were collected by casting the contents of the crucible onto a stainless steel plate. Samples that were immersed in boiling water dissolved in less than 1 hr. Samples left in the laboratory environment became sticky within a few hours. The composition was determined to be degradable and very hygroscopic.

### EXAMPLE 2

15 grams of SiO₂, 9.8 grams of K₂CO₃·H₂O and 6.3 grams of Na₂CO₃ were combined together by mixing using an alumina mortar and pestle. The mixture was placed in an alumina crucible and was heated in a laboratory furnace held at 1200° C. to yield a clear vitreous oxide with the composition of 68 mole percent SiO₂, 16 mole percent K₂O and 16 mole percent Na₂O. Fibers were extracted from the molten mass by inserting a glass rod into the mass and drawing out the fiber. Additional samples were collected by casting the contents of the crucible onto a stainless steel plate. Samples that were immersed in boiling water dissolved in less than 1 hr. Samples left in the laboratory environment did not become sticky after several hours. The composition was determined to be degradable but not hygroscopic.

### EXAMPLE 3

15 grams of SiO₂, 16.5 grams of K₂CO₃ H₂O and 0.4 grams of CaO were combined together by mixing using an alumina mortar and pestle. The mixture was placed in an alumina crucible and was heated in a laboratory furnace held at 1200° C. to yield a clear vitreous oxide with the composition of 70 mole percent SiO₂, 28 mole percent K₂O and 2 mole percent CaO. Fibers were extracted from the molten mass by inserting a glass rod into the mass and drawing out the fiber. Additional samples were collected by casting the contents of the crucible onto a stainless steel plate. Fibers of this composition became slightly sticky after exposure to the laboratory environment overnight. The composition was considered to be degradable and slightly hygroscopic.

### EXAMPLE 4

15 grams of SiO₂ and 13.3 grams of Na₂CO₃ H₂O were combined together by mixing using an alumina mortar and pestle. The mixture was placed in an alumina crucible and was heated in a laboratory furnace held at 1200° C. to yield a clear vitreous oxide with the composition of 70 mole percent SiO₂ and 30 mole percent Na₂O. Fibers were extracted from the molten mass by inserting a glass rod into the mass and drawing out the fiber. Additional samples were collected by casting the contents of the crucible onto a stainless steel plate. Fiber samples were placed in an aluminum pan in the laboratory environment for observation. After several days the surface of the fiber became frosted but did not become sticky. The composition was considered to be degradable but not hygroscopic.

The degradable vitreous oxide was placed in a heated platinum crucible with an orifice in the bottom. At a temperature of 1200° C. the material flowed through the orifice in the crucible and was drawn into fiber by engaging it upon a rotating drum. Fibers made in such a manner were coated with aluminum by bringing them into contact with the molten aluminum bath as in FIG. 4.

While the invention has been described herein with reference to specific embodiments and features, it will be appreciated the utility of the invention is not thus limited, yet, encompasses other variations, modifications, and alternative embodiments and, accordingly, the invention is, therefore, to be broadly construed as comprehending all such alternative variations, modifications, and other embodiments within its spirit and scope.

What is claimed is:

1. An alkali oxide siliceous material that is degradable in the presence of moisture.

2. A metal-coated substrate article, wherein the substrate is formed of a degradable alkali oxide siliceous material, and the metal is an oxidizable metal.

3. A degradable vitreous oxide of the composition R₂O:SiO₂ wherein R is a Group I alkali metal and wherein each R may be the same as or different from the other.

4. A degradable vitreous oxide according to claim 3, wherein each R is independently selected from the group consisting of sodium, lithium, and potassium.

5. A degradable vitreous oxide according to claim 3, wherein the composition R₂O:SiO₂ has a molar ratio of R₂O to SiO₂ in the range of from about 1:1 to about 1:6.

6. A degradable vitreous oxide according to claim 3, wherein the composition R₂O:SiO₂ has a molar ratio of R₂O to SiO₂ in the range of from about 1:2 to about 1:4.

7. A degradable vitreous oxide according to claim 2, wherein the metal is doped with a dopant material to facilitate oxidation of the metal.

8. A degradable vitreous oxide according to claim 7, wherein the dopant material comprises a salt selected from the group consisting of metal halide, metal sulfate, metal nitrate, metal citrate, metal stearate and metal acetate.

9. A degradable vitreous oxide according to claim 7, wherein the dopant material comprises a salt selected from the group consisting of lithium chloride, sodium chloride, potassium chloride, zinc chloride, iron (III) chloride and copper sulfate.

10. A method of making a moisture-degradable vitreous oxide, comprising blending together the oxides R₂O and SiO₂ and/or precursors of such oxides to form an oxides blend, and heating the blend at elevated temperature until the blended oxides fuse with one another to form the vitreous oxide.

11. A method of making a moisture-degradable chaff article, comprising blending together the oxides R₂O and SiO₂ and/or precursors of such oxides to form an oxides blend, and heating the blend at elevated temperature until the blended oxides fuse with one another to form a vitreous oxide, forming the vitreous oxide into a filament, and applying a metal coating to the filament.

12. A method according to claim 11, wherein the metal comprises aluminum.

13. A method according to claim 11, wherein the vitreous oxide is passed through a fiber-forming bushing to form the filament.

14. A method according to claim 11, wherein the metal coating is applied to the filament by contacting the filament with molten metal.

15. A method according to claim 11, wherein the metal coating is applied to the filament by vapor deposition.

16. A method according to claim 11, wherein the metal coating is doped with a dopant material to facilitate oxidation of the metal coating in exposure to moisture.

17. A degradable vitreous oxide according to claim 16, wherein the dopent material comprises a salt selected from the group consisting of metal halide, metal sulfate, metal nitrate, metal citrate, metal stearate and metal acetate.

18. A degradable vitreous oxide according to claim 16, wherein the dopant material comprises a salt selected from the group consisting of lithium chloride, sodium chloride, potassium chloride, zinc chloride, iron (III) chloride and copper sulfate.

19. A chaff article, comprising a substrate comprising a vitreous oxide of the composition R₂O:SiO₂ wherein R is a Group I alkali metal and wherein each R may be the same as or different from the other, and a metal film coated on the substrate.

20. A chaff article according to claim 19, wherein the metal film has an electromagnetic radiation-interactive character.

21. A chaff article according to claim 19, wherein the metal film comprises aluminum.

22. A chaff article according to claim 19, wherein the substrate is in the form of a filament.

23. A chaff article according to claim 19, wherein the metal film is doped with a dopant material.

24. A chaff article according to claim 23, wherein the dopent material comprises a salt selected from the group consisting of metal halide, metal sulfate, metal nitrate, metal citrate, metal stearate and metal acetate.

25. A chaff article according to claim 23, wherein the dopant material is a salt selected from the group consisting of lithium chloride, sodium chloride, potassium chloride, zinc chloride, iron (III) chloride and copper sulfate.

26. An electromagnetic radiation-interactive article comprising a metal film and an alkali oxide material, the metal film of an electromagnetic radiation-interactive size and shape, the metal film and alkali oxide material being arranged so that in exposure to ambient moisture the metal film is degradable to an -electromagnetic radiation-non-interactive form.

27. An electromagetic radiation-interactive article according to claim 26, wherein the metal film is degradable to an electromagnetic radiation-non-interactive form by degradation of an alkali oxide component of the alkali oxide material into a metal hydroxide that reacts with the metal film thereby rendering the metal film non-interactive with electromagnetic energy.

28. An electromagnetic radiation-interactive article according to claim 26, wherein the size, shape, and electromagnetic properties of the metal film render the article electromagnetic radiation-reflective in character.

29. An electromagnetic radiation-interactive article according to claim 26, wherein the size, shape, and electromagnetic properties of the metal film render the article electromagnetic radiation-absorptive in character.

30. An electromagnetic radiation-interactive article according to claim 26, wherein the size, shape, and electromagnetic properties of the metal film render the article electromagnetic radiation-reflective and electromagnetic radiation-absorptive in character.

31. An electromagnetic radiation-interactive article according to claim 26, wherein the alkali oxide material has the composition:
R₂O:SiO₂,
wherein R is a Group I alkali metal.

32. An electromagnetic radiation-interactive article according to claim 31, wherein the composition R₂O:SiO₂ has a molar ratio of R₂O to SiO₂ in the range of from about 1:1 to about 1:6.

33. An electromagnetic radiation-interactive article according to claim 31, wherein the composition R₂O:SiO₂ has a molar ratio of R₂O to SiO₂ in the range of from about 1:2 to about 1:4.

34. An electromagnetic radiation-interactive article according to claim 26, wherein the metal film comprises aluminum.

35. A radar interactive chaff material comprising:
a) a substrate having the composition:
R₂O:SiO₂,
wherein
R is a Group I alkali metal; and
b) a metal coating supported on the substrate, wherein exposure of the substrate to ambient moisture will cause alkali metal hydroxides to be formed and to oxidize the metal coating.

36. An electromagnetic radiation-interactive article according to claim 35, wherein the composition R₂O:SiO₂ has a molar ratio of R₂O to SiO₂ in the range of from about 1:1 to about 1:6.

37. An electromagnetic radiation-interactive article according to claim 35, wherein the composition R₂O:SiO₂ has a molar ratio of R₂O to SiO₂ in the range of from about 1:2 to about 1:4.

38. A radar interactive chaff material according to claim 35, wherein the metal coating comprises aluminum.

39. A method of making an electromagnetic radiation-interactive article, the method comprising:
a) providing a substrate having the composition:
R₂O:SiO₂,
wherein
each R is independently selected from Group I alkali metals;
b) coating the substrate with a metal, wherein exposure of the substrate to ambient moisture will cause alkali metal hydroxides to form and to degrade the metal coating.

40. An electromagnetic radiation-interactive article according to claim 39, wherein the composition R₂O:SiO₂ has a molar ratio of R₂O to SiO₂ in the range of from about 1:1 to about 1:6.

41. An electromagnetic radiation-interactive article according to claim 39, wherein the composition R₂O:SiO₂ has a molar ratio of R₂O to SiO₂ in the range of from about 1:2 to about 1:4.

42. A method of making an electromagnetic radiation-interactive article according to claim 39, further comprising fusing silica with a Group I alkali oxide to form the substrate.

43. A method of making an electromagnetic radiation-interactive article according to claim 39, wherein the substrate is a fiber.

44. A method of making an electromagnetic radiation-interactive article according to claim 39, wherein the substrate is coated with metal by contacting the substrate with molten metal.

45. A method of making an electromagnetic radiation-interactive article according to claim 39, wherein the substrate comprises a combination of different R₂O:SiO₂ compositions.
